(19) United States
(12) Patent Application Publication
(10) Pub. No.: US 2009/0167154 A1
(43) Pub. Date: Jul. 2, 2009

(54) WHITE PHOSPHOR, LIGHT EMISSION DEVICE INCLUDING THE SAME, AND DISPLAY DEVICE INCLUDING THE LIGHT EMISSION DEVICE

(75) Inventors: Seung-Joon Yoo, Yongin-si (KR); Zin-Min Park, Yongin-si (KR); Yun-Hee Kim, Yongin-si (KR); Jung-Ho Kang, Yongin-si (KR); Da-Ki Min, Yongin-si (KR); Su-Kyung Lee, Yongin-si (KR); Ji-Ryong Jung, Yongin-si (KR); Won-Il Lee, Yongin-si (KR)

Correspondence Address: STEIN MCEWEN, LLP, 1400 EYE STREET, NW, SUITE 300, WASHINGTON, DC, 20005, US

(73) Assignee: Samsung SDI CO., Ltd., Suwon-si (KR)

(21) Appl. No.: 12/326,208

(22) Filed: Dec. 2, 2008

(30) Foreign Application Priority Data
Dec. 26, 2007 (KR) 10-2007-0137650

(51) Int. Cl. H01J 1/62; C09K 11/59; C09K 11/56

(52) U.S. Cl. 313/503; 252/301.4 F; 252/301.4 S; 252/301.4 H

(57) ABSTRACT

A white phosphor, a light emission unit including the white phosphor, and a display device including the light emission unit are provided. The white phosphor comprises a green phosphor including a Tb-doped oxide host material, a blue phosphor and a red phosphor. The green phosphor doped with Tb is used as an activator, and has a wavelength which does not overlap with a wavelength of the blue phosphor, thereby improving color purity of the light emission device.

### CROSS-REFERENCE TO RELATED APPLICATIONS

This application claims priority to and the benefit of Korean Patent Application No. 2007-137650 filed in the Korean Intellectual Property Office on Dec. 26, 2007, the entire contents of which are incorporated herein by reference.

### BACKGROUND OF THE INVENTION

1. Field of the Invention

An aspect of the present invention relates to a white phosphor, a light emission device including the same, and a display device including the light emission device.

2. Description of the Related Art

A display device such as a liquid crystal display (LCD) device needs a separate light source unit to display an image.

Herein, the light source unit is commonly called a backlight unit. One type of backlight unit is a cold cathode fluorescent lamp (hereinafter referred to as a CCFL). Since a CCFL is a directional light source, light emitted therefrom can be uniformly dispersed through optical members such as a diffusion sheet, a diffusion plate, and a prism sheet towards a liquid crystal panel assembly.

However, since the light emitted from the CCFL may be lost due to the optical members, light with high intensity needs to be emitted, resulting in high power consumption. Furthermore, it is also difficult to use a large-sized backlight unit due to its structure limitation, and to apply this large-sized backlight unit to a large liquid crystal display of over 30 inches.

In addition, a backlight unit employing light emission diodes (LEDs) is well known. The LED is a spot light source and can thus be applied in a plurality of display devices. It constitutes a backlight unit along with optical members such as a reflection sheet, a light guide, a diffuser sheet, a diffuser, and a prism sheet. The LED type of backlight unit has a fast response time and good color reproduction. However, the LED is costly and increases the overall thickness of the liquid crystal display.

As described above, all the conventional backlight units have inherent problems. In addition, the conventional backlight units are driven so as to maintain a predetermined brightness all over a light emission surface when the liquid crystal display is driven. Therefore, it is difficult to improve the display quality.

For example, a backlight unit includes light-emitting phosphors emitting light due to the collision of electrons. The phosphors include green, blue, and red phosphors, and white light is emitted by mixing them. However, a backlight unit emitting white light formed by mixing more than 3 colors has overlapping wavelengths of green and blue phosphors, thereby deteriorating efficiency represented as a ratio of luminance against color purity and electric power.

### SUMMARY OF THE INVENTION

One embodiment of the present invention provides a white phosphor having improved color purity.

Another embodiment of the present invention provides a light emission device including the white phosphor.

Another embodiment of the present invention provides a display device including the light emission device as a backlight unit.

The embodiments of the present invention are not limited to the above technical embodiments, and other technical embodiments can also be understood by a person of ordinary skill in the art.

One embodiment of the present invention provides a white phosphor including a green phosphor having a Tb-doped oxide host material, a blue phosphor, and a red phosphor.

According to another embodiment of the present invention, the green phosphor is a compound selected from the group consisting of Y₂SiO₅:Tb, Y₂O₂S:Tb, LaOBr:Tb, La₂O₂S:Tb, Gd₂O₂S:Tb, Y₂O₃:Tb, and combinations thereof.

According to another embodiment of the present invention, the blue phosphor is a compound selected from the group consisting of ZnS:(Ag,Cl), ZnS:(Ag,Al), ZnS:(Ag,Al,Cl), Y₂SiO₅:Ce, Zn₂SiO₄:Ti, and combinations thereof.

According to another embodiment of the present invention, the red phosphor is a compound selected from the group consisting of Y₂O₃:Eu, Y₂O₃:(Eu,Tb), Y₂O₂S:Eu, Y₂O₂S:(Eu,Tb), and combinations thereof.

Another embodiment of the present invention provides a light emission device that includes first and second substrates arranged opposite to each other, a light emission unit disposed on one surface of the first substrate, and a light emission unit disposed on one surface of the second substrate. The light emission unit includes a phosphor layer disposed on one surface of the second substrate, and the phosphor layer includes the above white phosphor.

Still another embodiment of the present invention provides a display device that includes the above light emission device, and a display panel disposed on the front of the light emission device and receiving light emitted from the light emission device to display an image.

Another embodiment of the present invention will also be described in detail.

A white phosphor of the present invention includes a green phosphor including Tb as an activator so that wavelengths of the green and blue phosphors cannot overlap, thereby improving color purity. In addition, when the white phosphor is used for a light emission device, the white phosphor can improve the luminescence characteristics as well as the image quality of a display device.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 is a cross-sectional view of a light emission device according to an embodiment of the present invention;

FIG. 2 is a partial exploded perspective view of the light emission device of FIG. 1;

FIG. 3 is a partial exploded perspective view of the display device according to one embodiment of the present invention;

FIG. 4 shows a wavelength of the light emission device according to Example 1 of the present invention; and

FIG. 5 shows a wavelength of the light emission device according to Comparative Example 1.

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

One embodiment of the present invention provides a white phosphor including a green phosphor having a Tb-doped oxide host material, a blue phosphor, and a red phosphor.

The green phosphor having the Tb-doped oxide host material is a compound selected from the group consisting of Y₂SiO₅:Tb, Y₂O₂S:Tb, LaOBr:Tb, La₂O₂S:Tb, Gd₂O₂S:Tb, Y₂O₃:Tb, and combinations thereof.

As for the blue phosphor, a conventional blue phosphor may be used. Specific examples of the blue phosphor are compounds selected from the group consisting of ZnS:(Ag,Cl), ZnS:(Ag,Al), ZnS:(Ag,Al,Cl), Y₂SiO₅:Ce, Zn₂SiO₄:Ti, and combinations thereof.

As for the red phosphor, a conventional red phosphor may be used. Specific examples of the red phosphor are a compound selected from the group consisting of Y₂O₃:Eu, Y₂O₃:(Eu,Tb), Y₂O₂S:Eu, Y₂O₂S:(Eu,Tb), and combinations thereof.

When the green phosphor is measured regarding wavelength under 365 nm by using ultraviolet (UV) spectroscopy, the green phosphor has a main light emitting peak of less than 100 nm based on the value of a full width at half maximum (FWHM). In another embodiment, the green phosphor may have a main light emitting peak wavelength of less than 80 nm. In still another embodiment, the green phosphor may have a main light emitting peak wavelength ranging from 10 to 50 nm or from 30 to 50 nm.

When the green phosphor has a main light emitting peak wavelength within the above ranges, it does not overlap with a blue wavelength, thus improving color purity and luminance. Herein, the green phosphor has a main light emitting peak ranging from 500 to 580 nm.

An embodiment of the present invention provides a green phosphor including an oxide doped with Tb as an activator having a main light emitting wavelength of less than 100 nm, thereby not overlapping with the wavelength of a blue phosphor, thus improving color purity of a light emission device.

The green phosphor may be included in an amount ranging from 10 to 40 wt % based on the entire weight of a white phosphor. According to another embodiment, the green phosphor may be included in an amount ranging from 15 to 40 wt % or in an amount ranging from 15 to 30 wt %. When the green phosphor is included in an amount of less than 15 wt %, it may have deteriorated green luminance. On the other hand, when the green phosphor is included in an amount of more than 40 wt %, it may express white.

In addition, the blue phosphor may be included in an amount ranging from 10 to 50 wt % based on the entire weight of a white phosphor. According to another embodiment, the blue phosphor may be included in an amount ranging from 25 to 50 wt % or in an amount ranging from 15 to 40 wt %. When the blue phosphor is included in an amount of less than 10 wt %, it may deteriorate blue luminance. When the blue phosphor is included in an amount of more than 50 wt %, it may not express white.

In addition, the red phosphor may be included in an amount ranging from 10 to 35 wt % based on the entire weight of a white phosphor. According to another embodiment, the red phosphor may be included in an amount ranging from 15 to 30 wt %. When the red phosphor is included in an amount of less than 10 wt %, it may deteriorate red luminance. When the red phosphor is included in an amount of more than 35 wt %, it may express white.

Another embodiment of the present invention provides a light emission device that includes first and second substrates arranged opposite to each other, a light emission unit disposed on one surface of the first substrate, and a light emission unit disposed on one surface of the second substrate. The light emission unit includes a plurality of phosphor layers spaced apart from one another disposed on one surface of the second substrate. The phosphor layers include the above white phosphor.

The white phosphor includes a green phosphor including a Tb-doped oxide host material, a blue phosphor, and a red phosphor.

The green phosphor is a compound selected from the group consisting of Y₂SiO₅:Tb, Y₂O₂S:Tb, LaOBr:Tb, La₂O₂S:Tb, Gd₂O₂S:Tb, Y₂O₃:Tb, and combinations thereof.

As for the blue phosphor, a conventional blue phosphor may be used. Specific examples of the blue phosphor are compounds selected from the group consisting of ZnS:(Ag,Cl), ZnS:(Ag,Al), ZnS:(Ag,Al,Cl), Y₂SiO₅:Ce, Zn₂SiO₄:Ti, and combinations thereof.

As for the red phosphor, a conventional red phosphor may be used. Specific examples of the red phosphor are compounds selected from the group consisting of Y₂O₃:Eu, Y₂O₃:(Eu,Tb), Y₂O₂S:Eu, Y₂O₂S:(Eu,Tb), and combinations thereof.

When the green phosphor is measured regarding wavelength under 365 nm by using ultraviolet (UV) spectroscopy, the green phosphor has a main light emitting peak wavelength of 100 nm based on the value of full width at half maximum. According to one embodiment, the green phosphor may have a main light emitting peak wavelength of less than 80 nm. In another embodiment, the green phosphor may have a main light emitting peak wavelength ranging from 10 to 50 nm or 30 to 50 nm. When the green phosphor has a main light emitting peak wavelength within the above range, the green wavelength may not overlap with a blue wavelength, thus improving color purity and luminance. Herein, the green phosphor has a main light emitting peak in a range of 500 to 580 nm.

The present invention includes a green phosphor including Tb as an activator and having a main light emitting wavelength of less than 100 nm so that the green phosphor wavelength does not overlap with a blue phosphor wavelength, thereby improving color purity and efficiency of a light emission device.

The green phosphor may be included in an amount ranging from 10 to 40 wt % based on the entire weight of a white phosphor. In another embodiment, the green phosphor may be included in an amount ranging from 15 to 30 wt %. When the green phosphor is included in an amount of less than 15 wt %, it may deteriorate green luminance. When the green phosphor is included in an amount of more than 40 wt %, it may not express white.

In addition, the blue phosphor may be included in an amount ranging from 10 to 50 wt % based on the entire weight of a white phosphor. In another embodiment, the blue phosphor may be included in an amount ranging from 25 to 50 wt % or 15 to 40 wt %. When the blue phosphor is included in an amount of less than 10 wt %, it may deteriorate blue luminance. When the blue phosphor is included in an amount of more than 50 wt %, it may express white.

In addition, the red phosphor may be included in an amount ranging from 10 to 35 wt % based on the entire weight of a white phosphor. In another embodiment, the red phosphor may be included in an amount ranging from 15 to 30 wt %. When the red phosphor is included in an amount of less than 10 wt %, it may deteriorate red luminance. When the red phosphor is included in an amount of more than 35 wt %, it may not express white.

Another embodiment of the present invention provides a liquid crystal display (LCD) that includes the above light emission device, and a liquid crystal panel assembly disposed on the front of the light emission device and receiving light emitted from the light emission device to display an image.

Another embodiment of the present invention will be more fully described hereinafter with reference to the accompanying drawings, in which exemplary embodiments of the invention are shown.

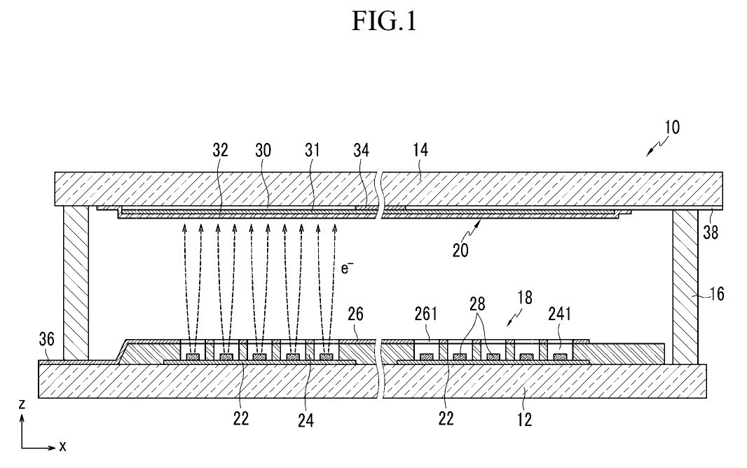

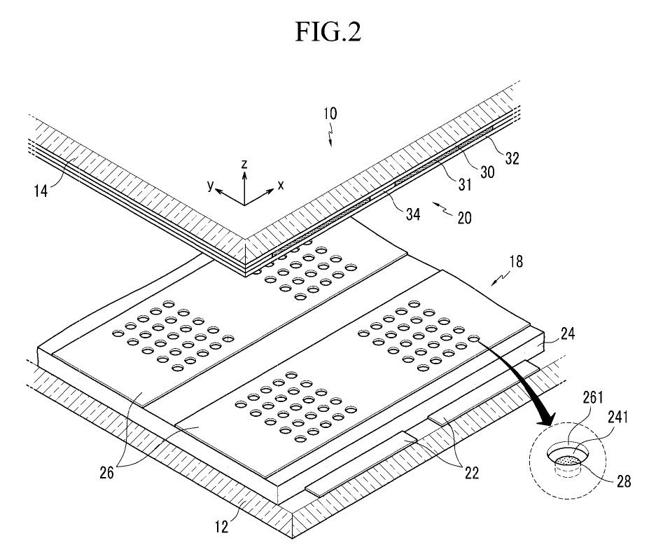

FIG. 1 is a sectional view of a light emission device according to an embodiment, and FIG. 2 is a partial exploded perspective view of the light emission device of FIG. 1.

Referring to FIG. 1, a light emission device 10 of the present embodiment includes first and second substrates 12 and 14 facing each other with a predetermined interval therebetween.

The first and second substrates 12 and 14 include a sealing member 16 at the peripheries thereof, to be sealed together and thus form a sealed envelope. The interior of the sealed envelope is kept to a degree of vacuum of about 10⁻⁶ Torr.

Each of the first and second substrates 12 and 14 has an active area emitting visible light and an inactive area surrounding the active area within an area surrounded by the sealing member 16. An electron emission unit 18 for emitting electrons is provided on the active area of the first substrate 12, and a light emission unit 20 for emitting the visible light is provided on the active area of the second substrate 14.

Referring to FIG. 2, the electron emission unit 18 includes cathodes 22 (first electrodes) arranged in a stripe pattern along one direction of the first substrate 12; gate electrodes 26 (second electrodes) arranged in a stripe pattern along a crossing direction thereof; an insulating layer 24 arranged between the cathodes 22 and gate electrodes 26; and electron emission regions 28 electrically connected to the cathodes 22.

The cathodes 22 can be arranged along the rows of the first substrate 12 and function as scan electrodes. Alternatively, the cathodes 22 can be arranged along the column of the first substrate 12 and function as data electrodes.

Openings 261 and 241 are formed through the insulating layer 24 and the gate electrode 26 at crossing regions of the cathodes 22 and gate electrodes 26 to partly expose the surface of the cathodes 22, and the electron emission regions 28 are formed on the cathodes 22 through the openings 241 of the insulating layer 24.

The electron emission regions 28 are formed of a material that emits electrons when an electric field is applied thereto under a vacuum atmosphere, such as a carbon-based material or a nanometer-sized material. The electron emission regions 28 can be formed of carbon nanotubes, graphite, graphite nanofibers, diamonds, diamond-like carbon, fullerene, silicon nanowires, or a combination thereof. The electron emission regions 32 can be formed through a screen-printing, direct growth, chemical vapor deposition, or sputtering process. Alternatively, the electron emission regions can be formed in a tip structure formed of a Mo-based or Si-based material.

One crossing region of the cathode 22 and gate electrode 26 may correspond to one pixel region of the light emission device 10. Alternatively, two or more crossing regions of the cathode 22 and gate electrode 26 may correspond to one pixel region of the light emission device 10. In this embodiment, two or more cathodes 22 and/or two or more gate electrodes 26 that are placed in one pixel region are electrically connected to each other to receive a common driving voltage.

The light emission unit 20 includes an anode 30, a phosphor layer 31 disposed on one surface of the anode 30, and a metal reflective layer 32 covering the phosphor layer 31. The anode 30 is driven by an anode voltage provided from outside of the vacuum container, and includes a transparent conductive layer such as indium tin oxide (ITO) so that it can transmit visible light emitted from the phosphor layer 31.

The metal reflective layer 32 is made of aluminum (Al) with a thickness of thousands of A, and includes minute holes through which an electron beam can pass. The metal reflective layer 32 plays a role of increasing luminance of a light emitting side by reflecting visible light emitted toward the first substrate 12 among visible light emitted from a phosphor layer 31 to the second substrate 14.

Furthermore, when the phosphor layers 31 are positioned on the second substrate 14 with a predetermined distance therebetween, a dark colored layer 34 may be positioned among them.

On the other hand, the anode of the present invention may be formed by using a transparent conductive layer rather than the metal reflective layer.

The phosphor layer 31 is formed of a white phosphor layer emitting white light. The white phosphor layer includes a white phosphor according to one embodiment of the present invention. The white phosphor includes a green phosphor selected from the group consisting of Y₂SiO₅:Tb, Y₂O₂S:Tb, LaOBr:Tb, La₂O₂S:Tb, Gd₂O₂S:Tb, Y₂O₃:Tb, and combinations thereof; a blue phosphor selected from the group consisting of ZnS:(Ag,Cl), ZnS:(Ag,Al), ZnS:(Ag,Al,Cl), Y₂SiO₅:Ce, Zn₂SiO₄:Ti, and combinations thereof; and a red phosphor selected from the group consisting of Y₂O₃:Eu, Y₂O₃:(Eu,Tb), Y₂O₂S:Eu, Y₂O₂S:(Eu,Tb), and combinations thereof.

One phosphor layer 31 may be disposed for one pixel region, or more than one phosphor layer 31 may be disposed for one pixel region. Also, one phosphor layer 31 may be disposed over two or more pixel regions.

Spacers (not shown) are disposed between the first and second substrates 12 and 14 for uniformly maintaining a gap therebetween against an outer force.

The light emission device 10 described above is driven by a voltage applied from the outside of the vacuum container to the cathodes 22, the gate electrodes 26, and the anode 30. In FIG. 1, reference numeral 36 indicates a gate lead line extended from the gate electrodes 26, and reference numeral 38 indicates an anode lead line extended from the anode.

An electric field is formed around the electron emission regions 28 at pixel regions where a voltage difference between the cathodes 22 and gate electrodes 26 is higher than a threshold value, thereby emitting electrons from the electron emission regions 28. The emitted electrons are accelerated by the high voltage applied to the metal reflective layer 32 to collide with the corresponding phosphor layer 31, thereby exciting the phosphor layer 31.

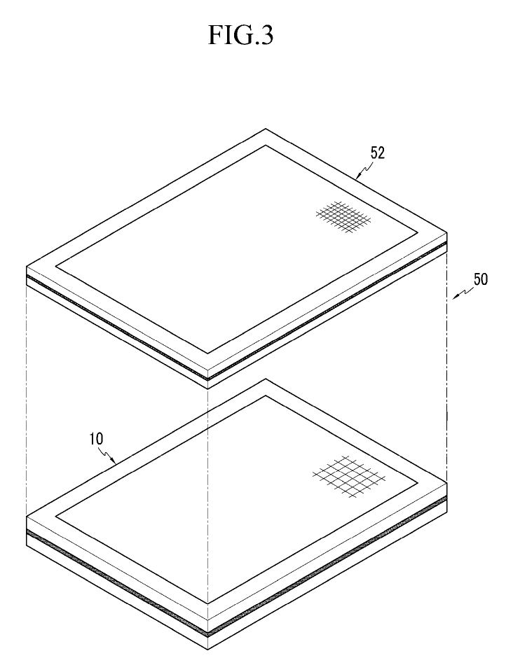

FIG. 3 is an exploded perspective view of a display device according to an exemplary embodiment of the present invention.

Referring to FIG. 3, a liquid crystal display (LCD) 50 according to one embodiment includes a display panel 52 including a plurality of pixels along a row direction and a column direction, and a light emission device 10 disposed at rear of the display panel 52 and providing the display panel 52 with light. For the display panel 52, a conventional liquid crystal panel assembly can be used. The above-described light emission device 10 can be used as a backlight unit.

The following examples illustrate the embodiment of the present invention in more detail. However, it is understood that the present invention is not limited by these examples.

### EXAMPLE 1

35 wt % of a Y₂SiO₅:Tb green phosphor, 35 wt % of a ZnS:(Ag,Al) blue phosphor, and 30 wt % of a Y₂O₃:Eu red phosphor were mixed to prepare a white phosphor.

Next, an anode was formed by using ITO in an active area on a substrate, and the white phosphor was used to form a phosphor layer thereon.

Then, a dark colored layer was formed among the phosphor layers, and Al was chemically vapor-disposed on the front side of the substrate to form a metal reflective layer. Subsequently, the substrate was fired at 480° C. for 30 minutes to prepare a light emission unit.

### EXAMPLE 2

A light emission unit was prepared according to the same method as in Example 1, except that 40 wt % of a Y₂O₂S:Tb green phosphor, 20 wt % of a ZnS:(Ag,Al) blue phosphor, and 40 wt % of a Y₂O₃:(Eu,Tb) red phosphor were mixed to prepare a white phosphor.

### EXAMPLE 3

A light emission unit was prepared according to the same method as in Example 1, except that 50 wt % of a LaOBr:Tb green phosphor, 20 wt % of a ZnS:(Ag,Al,Cl) blue phosphor, and 30 wt % of a Y₂O₂S:(Eu,Tb) red phosphor were mixed to prepare a white phosphor.

### COMPARARTIVE EXAMPLE 1

A light emission unit was prepared according to the same method as in Example 1, except that 35 wt % of a ZnS:(Cu,Al) green phosphor, 35 wt % of a ZnS:(Ag,Al) blue phosphor, and 30 wt % of a Y₂O₂S:Eu red phosphor were mixed to prepare a white phosphor.

### COMPARATIVE EXAMPLE 2

A light emission unit was prepared according to the same method as in Example 1, except that 30 wt % of a SrGa₂S₄:Eu green phosphor, 40 wt % of a ZnS:(Ag,Al) blue phosphor, and 30 wt % of a Y₂O₂S:Eu red phosphor were mixed to prepare a white phosphor.

Wavelength Measurement

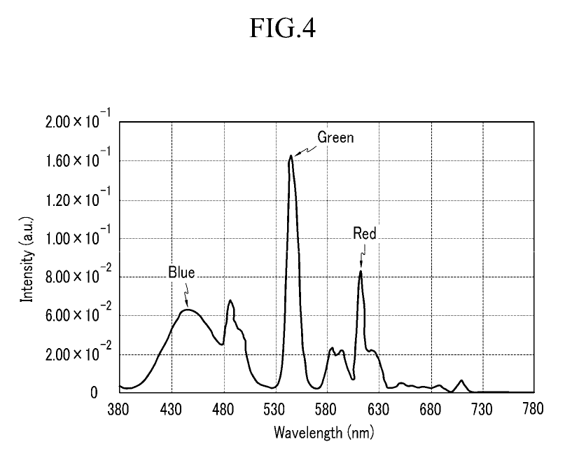

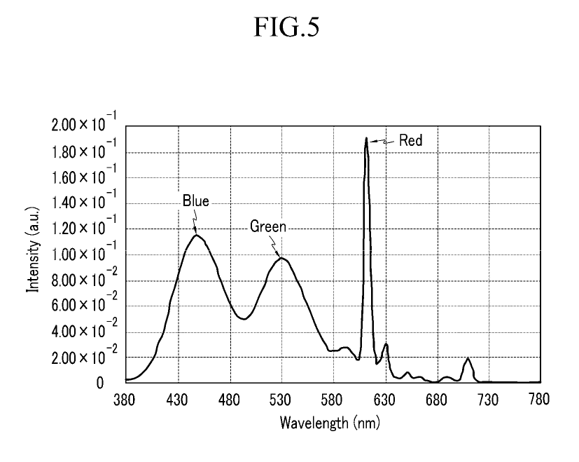

FIG. 4 is a graph showing the wavelength of the white phosphor according to Example 1, which was measured using ultraviolet (UV) spectroscopy. FIG. 5 is a graph showing the wavelength of the white phosphor according to Comparative Example 1, which was also measured using ultraviolet (UV) spectroscopy. Herein, the white phosphor was measured with respect to a wavelength ranging from 300 nm to 800 nm at room temperature.

As shown in FIG. 4, the white phosphor has a main light emitting peak wavelength of a green phosphor of 30 nm at around 550 nm, and a main light emitting peak of a blue phosphor of 70 nm at around 450 nm. As a result, since Example 1 has more than a 40 nm wavelength difference between green and blue phosphors, the green and blue phosphors have no overlapping wavelengths.

Referring to FIG. 5, the white phosphor has a main light emitting peak wavelength of a green phosphor of 70 nm at around 530 nm, and a main light emitting peak wavelength of a blue phosphor of 70 nm at around 450 nm. As a result, since Comparative Example 1 has very similar wavelengths between green and blue phosphors, the green and blue phosphors have overlapping wavelengths.

Accordingly, since the green and blue phosphors do not have overlapping wavelengths, as illustrated in FIG. 4 of Example 1, color purity and efficiency of a light emission device can be improved.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A white phosphor comprising:
a green phosphor including a Tb-doped oxide host material;
a blue phosphor; and
a red phosphor.

2. The white phosphor of claim 1, wherein the green phosphor including the Tb-doped oxide host material comprises a compound selected from the group consisting of Y₂SiO₅:Tb, Y₂O₂S:Tb, LaOBr:Tb, La₂O₂S:Tb, Gd₂O₂S:Tb, Y₂O₃:Tb, and combinations thereof.

3. The white phosphor of claim 1, wherein the blue phosphor comprises a compound selected from the group consisting of ZnS:(Ag,Cl), ZnS:(Ag,Al), ZnS:(Ag,Al,Cl), Y₂SiO₅:Ce, Zn₂SiO₄:Ti, and combinations thereof.

4. The white phosphor of claim 1, wherein the red phosphor comprises a compound selected from the group consisting of Y₂O₃:Eu, Y₂O₃:(Eu,Tb), Y₂O₂S:Eu, Y₂O₂S:(Eu,Tb), and combinations thereof.

5. The white phosphor of claim 1, wherein the green phosphor has a light emitting peak wavelength of less than 100 nm.

6. The white phosphor of claim 1, wherein the green phosphor comprising the Tb-doped oxide host material has a light emitting peak wavelength of less than 80 nm.

7. The white phosphor of claim 1, wherein the green phosphor has a light emitting peak wavelength ranging from 10 to 50 nm.

8. The white phosphor of claim 1, wherein the green phosphor is 10 to 40 wt % based on an entire weight of the white phosphor.

9. The white phosphor of claim 1, wherein the blue phosphor is 10 to 50 wt % based on an entire weight of the white phosphor.

10. The white phosphor of claim 1, wherein the red phosphor is 10 to 35 wt % based on an entire weight of the white phosphor.

11. A light emission device comprising:
first and second substrates arranged opposite to each other;
an electron emission unit disposed on one side of the first substrate; and
a light emission unit disposed on one side of the second substrate,
wherein the light emission unit comprises a phosphor layer disposed on the second substrate, and the phosphor layer includes a white phosphor, the white phosphor comprising:
a green phosphor including a Tb-doped oxide host material;
a blue phosphor; and
a red phosphor.

12. The light emission device of claim 11, wherein the green phosphor including the Tb-doped oxide host material comprises a compound selected from the group consisting of Y₂SiO₅:Tb, Y₂O₂S:Tb, LaOBr:Tb, La₂O₂S:Tb, Gd₂O₂S:Tb, Y₂O₃:Tb, and combinations thereof.

13. The light emission device of claim 11, wherein the blue phosphor comprises a compound selected from the group consisting of ZnS:(Ag,Cl), ZnS:(Ag,Al), ZnS:(Ag,Al,Cl), Y₂SiO₅:Ce, Zn₂SiO₄:Ti, and combinations thereof.

14. The light emission device of claim 11, wherein the red phosphor comprises a compound selected from the group consisting of Y₂O₃:Eu, Y₂O₃:(Eu,Tb), Y₂O₂S:Eu, Y₂O₂S:(Eu,Tb), and combinations thereof.

15. The light emission device of claim 11, wherein the green phosphor has a light emitting peak wavelength of less than 100 nm.

16. The light emission device of claim 11, wherein the green phosphor is 10 to 40 wt % based on an entire weight of the white phosphor.

17. The light emission device of claim 11, wherein the blue phosphor is 10 to 50 wt % based on an entire weight of the white phosphor.

18. The light emission device of claim 11, wherein the red phosphor is 10 to 35 wt % based on an entire weight of the white phosphor.

19. A display device comprising:
a light emission device including a light emission unit; and
a display panel positioned on the front side of the light emission device and showing an image with light emitted from the light emission device,
wherein the light emission unit includes a phosphor layer having a white phosphor, the white phosphor comprising: a green phosphor including a Tb-doped oxide host material; a blue phosphor; and a red phosphor.

20. The white phosphor of claim 1, wherein wavelengths of the green and blue phosphors do not overlap.
